(19) United States
(12) Patent Application Publication
(10) Pub. No.: US 2025/0102993 A1
(43) Pub. Date: Mar. 27, 2025

(54) IMAGE FORMING APPARATUS AND WASTE POWDER COLLECTION BOTTLE

(71) Applicant: FUJIFILM Business Innovation Corp, Tokyo (JP)

(72) Inventor: Masaya FUKUSHIMA, Kanagawa (JP)

(73) Assignee: FUJIFILM Business Innovation Corp, Tokyo (JP)

(21) Appl. No.: 18/432,675

(22) Filed: Feb. 5, 2024

(30) Foreign Application Priority Data
Sep. 26, 2023 (JP) 2023-163020

(51) Int. Cl. G03G 21/12; G03G 15/00; G03G 21/10

(52) U.S. Cl. CPC G03G 21/12; G03G 15/55; G03G 21/105

(57) ABSTRACT

An image forming apparatus includes: a collection container configured to receive waste powder discharged from an image forming unit and store the waste powder; a conveying portion that is 7swingably supported in a cantilevered manner in the collection container and is inclined according to a height of the waste powder deposited in the collection container to convey the waste powder; and an output unit configured to output collection amount information that is information on an amount of the waste powder stored in the collection container based on a position of the conveying portion in the collection container.

### CROSS-REFERENCE TO RELATED APPLICATIONS

This application is based on and claims priority under 35 USC 119 from Japanese Patent Application No. 2023-163020 filed Sep. 26, 2023.

### BACKGROUND

### (i) Technical Field

The present invention relates to an image forming apparatus and a waste powder collection bottle.

### (ii) Related Art

Japanese Unexamined Patent Application Publication No. 2017-102155 discloses an image forming apparatus including a waste toner collection unit for collecting waste toner and an image forming unit to which the waste toner collection unit is detachably attached. The waste toner collection unit includes a toner container that stores the waste toner and an auger with which the waste toner is leveled so as not to be accumulated on one side. The image forming unit includes an auger motor that drives the auger, a torque sensor that detects a load on the auger motor, and a state detection unit. The state detection unit detects the amount of waste toner in the toner container based on the load on the auger motor detected by the torque sensor.

Japanese Unexamined Patent Application Publication No. 2015-225156 discloses an untransferred toner collecting device including a collection container that collects, as waste toner, untransferred toner removed from a surface of a photoconductor drum by a cleaning unit. A conveying and agitating screw that is connected to a drive source via a drive path and agitates and levels the collected untransferred toner while conveying the untransferred toner by a rotating operation is provided in the collection container. The drive path is provided with a torque limiter that detects a rotational torque for the conveying and agitating screw and blocks the drive path to interrupt torque transmission to the conveying and agitating screw when the rotational torque increases to a set value with an increase in the toner collected amount.

### SUMMARY

A waste powder collection bottle that is a bottle for collecting waste powder such as waste toner includes one that is provided with a detection window. Detection of a full state of such a waste powder collection bottle is made through detection by a transmission-type sensor. With the method using the transmission-type sensor for the detection of the full state, the transmission-type sensor may make false detection due to the waste powder scattering in the waste powder collection bottle and attaching to the detection window. On top of that, the use of a transmission-type sensor using an electronic component leads to an increase in the product price.

Aspects of non-limiting embodiments of the present disclosure relate to detecting the amount of waste powder stored in a waste powder collection bottle while suppressing the use of an electronic component material for the waste powder collection bottle.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

An image forming apparatus includes: a collection container configured to receive waste powder discharged from an image forming unit and store the waste powder; a conveying portion that is swingably supported in a cantilevered manner in the collection container and is inclined according to a height of the waste powder deposited in the collection container to convey the waste powder; and an output unit configured to output collection amount information that is information on an amount of the waste powder stored in the collection container based on a position of the conveying portion in the collection container.

### BRIEF DESCRIPTION OF THE DRAWINGS

Exemplary embodiments of the present disclosure will be described in detail based on the following figures, wherein:

FIG. 1 is a diagram illustrating an image forming apparatus to which the present exemplary embodiment is applied;

FIG. 2 is a diagram illustrating a configuration of a waste powder collection bottle;

FIGS. 3A to 3D are diagrams illustrating how an agitator member moves until an empty collection container becomes full;

FIG. 4 is a block diagram illustrating a functional configuration of a controller; and

FIG. 5 is a flowchart of processing for detecting that the collection container is full.

### DETAILED DESCRIPTION

### Image Forming Apparatus 1

Exemplary embodiments of the present invention will be described below in detail with reference to the accompanying drawings.

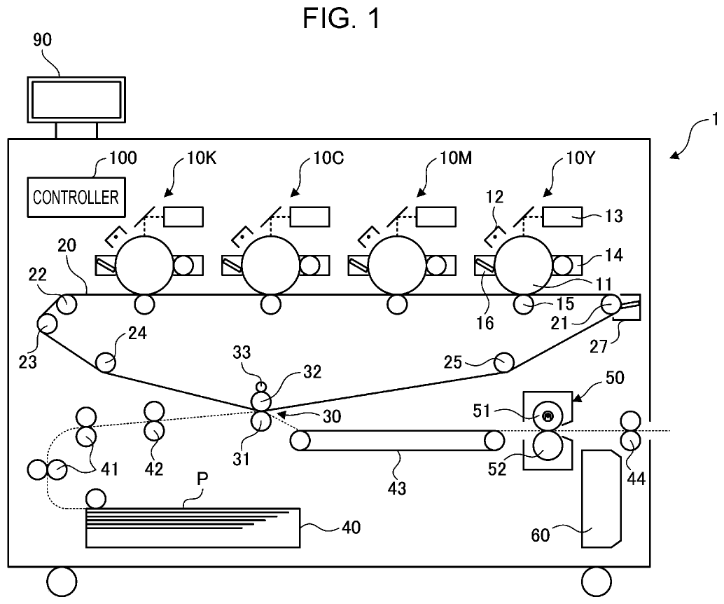

FIG. 1 is a diagram illustrating an image forming apparatus 1 to which the present exemplary embodiment is applied. The image forming apparatus 1 includes a plurality of image forming units 10 in which toner images of respective color components are formed by an electrophotographic system. In the present exemplary embodiment, the image forming apparatus 1 includes four image forming units 10Y, 10M, 10C, and 10K.

The image forming apparatus 1 further includes an intermediate transfer belt 20 on which the toner images of the respective color components formed by the image forming units 10 are sequentially transferred (primary transferred) and held. Furthermore, the image forming apparatus 1 includes a secondary transfer device 30 that collectively transfers (secondarily transfers) the superimposed images that have been transferred to the intermediate transfer belt 20, onto a sheet P as a recording material, and a fixing device 50 that fixes the secondarily transferred image on the sheet P. These components are accommodated in the main body of the image forming apparatus 1.

In addition, the image forming apparatus 1 includes a user interface 90 that includes a touch panel or the like, displays information to a user, and receives an input from the user. The image forming apparatus 1 further includes a controller 100 that controls the image forming apparatus 1.

Here, the image forming unit 10 for each color component includes a photoconductor drum 11 and a charging device 12 that charges the photoconductor drum 11 to a predetermined potential. The image forming unit 10 further includes a laser exposure device 13 that writes an electrostatic latent image on the charged photoconductor drum 11 and a developing device 14 that stores toner of each color component and develops the electrostatic latent image on the photoconductor drum 11. The image forming unit 10 further includes a primary transfer roller 15 that transfers the toner image carried on the photoconductor drum 11 onto the intermediate transfer belt 20, and a drum cleaner 16 that removes a residue on the photoconductor drum 11 after the primary transfer.

The developing device 14 employs a two-component developing method using so-called two-component developer (hereinafter, referred to as developer) including a toner and a carrier. Furthermore, each developing device 14 according to the present exemplary embodiment employs a so-called trickle method in which new developer is supplied into the developing device 14 at a predetermined timing and the resulting surplus developer is discharged to the outside as waste developer. With this configuration, it is possible to remove the carrier that has deteriorated due to long-term use, whereby the developing performance can be guaranteed.

The intermediate transfer belt 20 is spanned across a plurality of support rollers 21 to 25 and a backup roller 32 of the secondary transfer device 30 described later. Here, the support roller 21 functions as a driving roller of the intermediate transfer belt 20. The support rollers 22 to 25 are used as driven rollers. A belt cleaner 27 for removing a residue on the intermediate transfer belt 20 after the secondary transfer is disposed at a portion of the intermediate transfer belt 20 sandwiching the support roller 21.

The secondary transfer device 30 includes a second transfer roller 31 that is disposed in pressure contact with the toner-image-carrying surface of the intermediate transfer belt 20, and the backup roller 32 that is disposed on the back surface side of the intermediate transfer belt 20 and serves as a counter electrode for the second transfer roller 31. Furthermore, in the secondary transfer device 30, a power feeding roller 33 that applies a secondary transfer bias having the same polarity as the toner charging polarity to the backup roller 32 is disposed in contact with the backup roller 32.

In a sheet conveyance system, a sheet P loaded on a sheet tray 40 is picked up by nudger rollers 41, temporarily stopped by registration rollers 42, and then is fed to a secondary transfer position of the secondary transfer device 30 at a predetermined timing. In addition, the sheet P after the secondary transfer is transported to the fixing device 50 through a conveyer belt 43, and the sheet P discharged from the fixing device 50 is discharged to the outside of the apparatus by discharge rollers 44.

The fixing device 50 includes a heating roller 51 that has a heating source therein and is rotatably disposed. The fixing device 50 further includes a pressure roller 52 that is disposed in pressure-contact with the heating roller 51 and rotates to follow the heating roller 51.

Furthermore, the image forming apparatus 1 according to the present exemplary embodiment is provided with a waste powder collection bottle 60 for collecting waste powder discharged from an image forming unit. In the waste powder collection bottle 60, waste developer discharged from the developing device 14 due to supply of new developer and waste powder discharged from the image forming unit, such as waste toner removed by the drum cleaner 16 or the belt cleaner 27, are collected. The waste powder collection bottle 60 is replaceably attached to the image forming apparatus 1. When the waste powder collection bottle 60 becomes full of waste powder, the waste powder collection bottle 60 is removed from the image forming apparatus 1 by a user, and a new waste powder collection bottle 60 is attached, thereby replacing the waste powder collection bottle 60.

### Waste Powder Collection Bottle

Next, the waste powder collection bottle 60 will be described in detail.

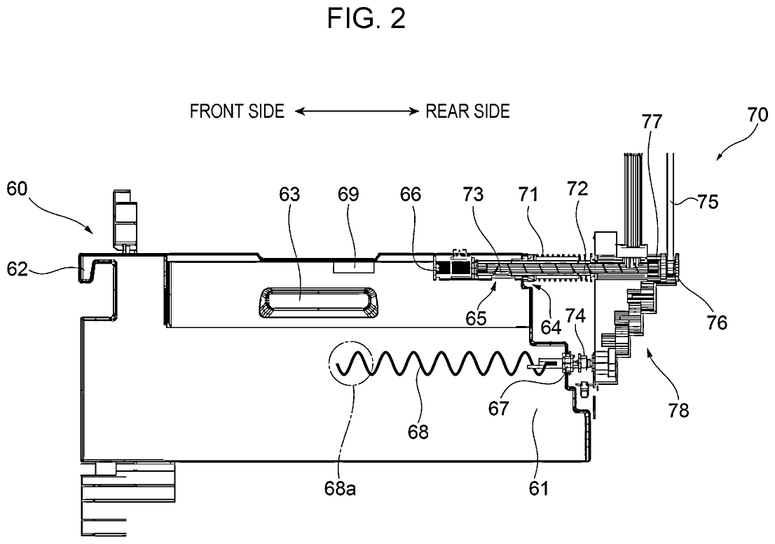

FIG. 2 is a diagram illustrating a configuration of the waste powder collection bottle 60. FIG. 2 illustrates an attachment part 70 for attaching the waste powder collection bottle 60 to the image forming apparatus 1, which is a main body side. The right side and the left side of FIG. 2 are respectively defined as a “rear side”, which is the back side of the image forming apparatus 1, and a “front side”, which is the front side of the image forming apparatus 1. The waste powder collection bottle 60 is pushed from the front side toward the rear side, to be replaceably attached to the attachment part 70 provided in the main body of the image forming apparatus 1.

The waste powder collection bottle 60 includes a collection container 61 that receives and stores waste powder ejected from the image forming unit 10 of the image forming apparatus 1, a handle 62 that is used when the waste powder collection bottle 60 is attached to and detached from the image forming apparatus 1, and a grip 63 that facilitates carrying of the waste powder collection bottle 60. The waste powder collection bottle 60 includes an insertion port 64 for inserting a conveying pipe 71 for conveying the waste powder into the collection container 61, an inlet 65 through which the waste powder is received in the collection container 61, and an automatic shutter 66 for closing the inlet 65. The waste powder collection bottle 60 further includes an agitator member 68 that conveys and agitates the waste powder in the collection container 61, a coupling member 67 that holds the agitator member 68, and a brake part 69 that comes into contact with the agitator member 68 in response to an increase in the waste powder in the collection container 61.

The handle 62 is formed so as to protrude on the front side of the collection container 61. When removing the waste powder collection bottle 60 from the image forming apparatus 1, the user can hold the handle 62 and pull out the waste powder collection bottle 60 toward the front side.

The grip 63 is a recess provided on the upper side of the central portion of the collection container 61. The user can carry the waste powder collection bottle 60 removed from the image forming apparatus 1 with his or her fingers inserted in the recess, that is, the grip 63 of the waste powder collection bottle 60.

The insertion port 64 is provided on an upper side surface on the rear side of the collection container 61. The inlet 65 through which the waste powder discharged from a discharge port 73 of the conveying pipe 71 is received in the collection container 61 is provided on the inner lower side of the insertion port 64.

The automatic shutter 66 is provided inside the insertion port 64, opens the inlet 65 when the conveying pipe 71 is inserted into the insertion port 64, and closes the inlet 65 when the conveying pipe 71 is pulled out from the insertion port 64. The automatic shutter 66 is biased toward the rear side by a biasing member such as a spring, and opens the inlet 65 upon being pushed by the conveying pipe 71, for example.

The coupling member 67 is provided on a side surface of a substantially central portion on the rear side of the collection container 61 to be formed through the collection container 61, in a rotatable manner. The coupling member 67 is attached to the collection container 61 via a seal or the like, and prevents the waste powder stored in the collection container 61 from leaking to the outside. The coupling member 67 includes, on the inner side of the collection container 61, a holding portion for holding the agitator member 68. The coupling member 67 is provided, on the outer side of the collection container 61, with a protrusion for meshing with a coupling receiving member 74 described later for coupling to the coupling receiving member 74.

The agitator member 68 is made of, for example, a metal such as stainless steel formed into a spiral shape. The agitator member 68 is swingably supported in a cantilever manner by the coupling member 67, and rotates with the rotation of the coupling member 67. Furthermore, in the present exemplary embodiment, the agitator member 68 extends to a substantially central portion in the collection container 61, and an end portion thereof on the front side that is not attached to the coupling member 67 is a free end.

The agitator member 68 functioning as an example of a conveying portion conveys the waste powder from the rear side to the front side while rotating in the collection container 61. Furthermore, the agitator member 68 itself receives a pressure in a direction away from the waste powder while conveying the waste powder by rotating. Therefore, the agitator member 68 is lifted above the waste powder instead of being buried in the waste powder deposited from below. The agitator member 68 is inclined, according to the height of the waste powder deposited in the collection container, about one end supported by the coupling member 67 in a cantilever manner, and conveys the waste powder.

Furthermore, a distal end portion 68a that is a distal end of the agitator member 68 on the free end side is processed to facilitate generation of frictional force in response to the contact with the brake part 69. For example, the distal end portion 68a is processed to have high surface roughness. This processing is performed, for example, by shaving the surface of the distal end portion 68a with a file or the like. Furthermore, for example, the distal end portion 68a may be covered with rubber or the like having a friction coefficient larger than the friction coefficient of the metal used for the agitator member 68 to facilitate the generation of the frictional force.

Here, the distal end portion 68a may have a certain width in the longitudinal direction of the agitator member 68 as well as the most distal end portion of the agitator member 68 on the free end side. Here, the certain width corresponds to a range in which the free end side of the agitator member 68 is expected to contact the brake part 69. For example, the distal end portion 68a may have a width of several pitches, where the pitch is defined as a length in the longitudinal direction of one turn of the agitator member 68 wound into a spiral shape.

The brake part 69 is provided on the upper side of the collection container 61, and is provided at a position where the brake part 69 comes into contact with the distal end portion 68a of the agitator member 68 when the position of the agitator member 68 is changed according to the amount of the waste powder in the collection container 61. The brake part 69 functioning as an example of a resistance applying portion applies a frictional force in a direction opposite to a direction in which the agitator member 68 rotates when the distal end portion 68a comes into contact with the brake part 69. In other words, the brake part 69 generates a frictional resistance at the distal end portion 68a of the agitator member 68.

An example of the material of the brake part 69 may include felt cloth and sponge, for example. Furthermore, the inner surface of the upper surface of the collection container 61 may be processed to be rough. In the present exemplary embodiment, as the brake part 69, sheet-like felt cloth is fixed in an area of the inner upper surface of the collection container 61 with which the distal end portion 68a is in contact.

### Attachment Part

The attachment part 70 includes the conveying pipe 71 serving as a conduit for conveying the waste powder into the collection container 61, a conveying auger 72 for conveying the waste powder in the conveying pipe 71, and the discharge port 73 for discharging the waste powder into the collection container 61. Furthermore, the attachment part 70 includes the coupling receiving member 74 that engages with the coupling member 67 of the collection container 61 to drivingly rotate the coupling member 67.

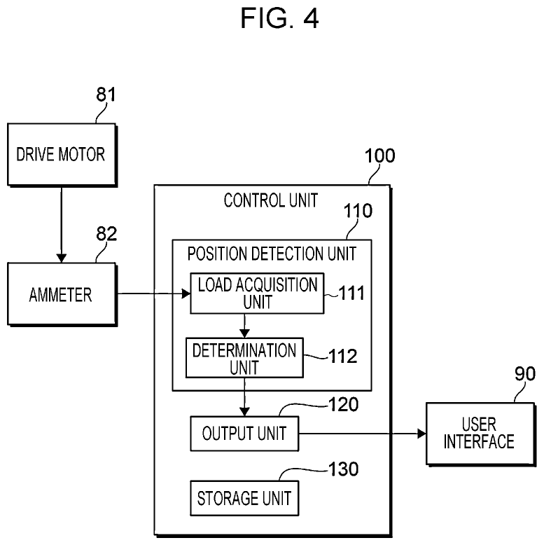

The attachment part 70 further includes a circumferential transmission belt 75 that transmits power generated from a drive motor 81 (see FIG. 4) that is an example of a drive source, and a pulley 76 that is provided at an end portion of the conveying auger 72 and to which the transmission belt 75 is attached. The attachment part 70 further includes a coaxial gear 77 that is provided coaxially with the conveying auger 72 and rotates as the pulley 76 rotates, and a gear group 78 of a plurality of stages that receives a driving force from the coaxial gear 77 and transmits the driving force to the coupling receiving member 74.

The conveying pipe 71 is sized to be insertable into the insertion port 64. The conveying auger 72 is rotatably provided in the conveying pipe 71. The waste powder discharged from the developing device 14, the drum cleaner 16, and the belt cleaner 27 is conveyed from the discharge port 73 to the waste powder collection bottle 60 by the conveying pipe 71 and the conveying auger 72.

The coupling receiving member 74 is engaged with and coupled to the protrusion of the coupling member 67 when the waste powder collection bottle 60 is attached. The coupling receiving member 74 transmits the driving force from the drive motor 81 transmitted via the gear group 78 and the like, to the coupling member 67. Thus, in the image forming apparatus 1 to which the present exemplary embodiment is applied, the driving force from the drive motor 81 is transmitted to the conveying auger 72 and the agitator member 68.

### Operation of Agitator Member

Next, an operation of the agitator member 68 in the collection container 61 will be described.

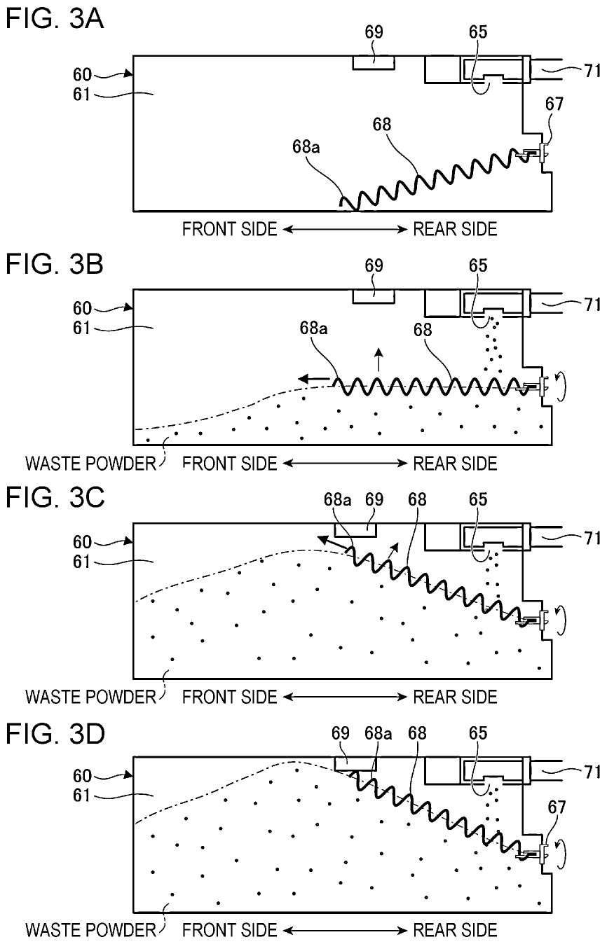

FIGS. 3A to 3D are diagrams illustrating the positions of the agitator member 68 from an empty state to a full state in the collection container 61.

FIG. 3A illustrates an initial stage, that is, a state in which the waste powder is not collected in the collection container 61. In this state, the agitator member 68 has the distal end portion 68a on the free end side oriented downward and touching the bottom of the collection container 61, due to its own weight. Next, when an image forming operation is performed in the image forming apparatus 1, waste powder generated as a result of the image formation is conveyed in the conveying pipe 71. In this process, the conveying auger 72 is drivingly rotated by the transmission belt 75, whereby the waste powder is discharged from the discharge port 73 provided in the conveying pipe 71 and conveyed into the collection container 61 through the inlet 65. Similarly, the coupling member 67 is drivingly rotated by the transmission belt 75, and the agitator member 68 is rotated in the collection container 61 in accordance with the rotation of the coupling member 67.

The waste powder conveyed into the collection container 61 through the inlet 65 is first deposited on the bottom portion (rear side bottom portion) of the collection container 61 immediately below the inlet 65. When a certain amount of waste powder is deposited in the collection container 61, the waste powder on the upper side is conveyed toward the front side of the collection container 61 by the rotating agitator member 68. FIG. 3B illustrates a state of this process. As can be seen in FIG. 3B that the height of the waste powder is leveled in the collection container 61 due to the waste powder being conveyed by the agitator member 68. Then, the agitator member 68 receives a pressure from the waste powder deposited in the collection container 61, to be lifted about the attachment position with respect to the coupling member 67, and thus moves upward from the position illustrated in FIG. 3A. Specifically, when the agitator member 68 swings, the agitator member 68 is positioned at an angle to be at substantially the same height as the upper surface of the waste powder deposited in the collection container 61.

FIG. 3C illustrates a state in which waste powder is further conveyed into the collection container 61 and the collection container 61 is nearly full. In this state, the agitator member 68 has moved to an upper surface level of the deposited waste powder, and thus has the free end side being higher than the coupling member 67 side. In the waste powder collection bottle 60, as illustrated in FIGS. 3A to 3C, the agitator member 68 conveys the waste powder while being disposed over the waste powder until the inside of the collection container 61 changes from the empty state to the nearly full state. Therefore, the frictional force that the agitator member 68 receives from the waste powder is smaller than that in a case where the agitator member 68 is buried in the waste powder. Thus, a variation in the load applied to the drive motor 81 for driving the agitator member 68 is small.

FIG. 3D illustrates a state in which waste powder is further conveyed into the collection container 61 and the collection container 61 is full. In this state, the distal end portion 68a of the agitator member 68 is sandwiched between the brake part 69 of the collection container 61 and the waste powder, and is pressed against the brake part 69. When the agitator member 68 is rotating while being in contact with the brake part 69, a frictional force is generated in a direction of resistance against the rotation direction. Thus, a larger amount of force is required for rotating the agitator member 68. In other words, when the agitator member 68 contacts the brake part 69, a load applied to a drive source that rotates the agitator member 68 increases. In the image forming apparatus 1 to which the present exemplary embodiment is applied, the position of the agitator member 68 is detected by detecting the load thus increased.

### Function of Controller

Next, the function of the controller 100 to detect the full state will be described.

FIG. 4 is a block diagram illustrating a functional configuration of the controller 100. FIG. 4 further illustrates the drive motor 81 that drives the agitator member 68, an ammeter 82 that is an example of a measurement unit that detects a load applied to the drive motor 81, and the user interface 90 that receives an output from the controller 100 and presents information to the user.

As described above, the drive motor 81 rotates the agitator member 68 via the transmission belt 75, the gear group 78, and the like. When the torque required to rotate the agitator member 68 increases, the load applied to the drive motor 81 increases, and the current value of the electric power input to the drive motor 81 increases.

The ammeter 82 is connected to the drive motor 81, and measures a current value of electric power input to the drive motor 81.

The controller 100 includes a position detection unit 110 that detects the position of the agitator member 68, an output unit 120 that outputs collection amount information, which is information about the amount of waste powder stored in the collection container 61, to the user interface 90 based on the position of the agitator member 68, and a storage unit 130 that stores various setting values used for processing executed by the controller 100, acquired measurement values, and the like.

The position detection unit 110 includes a load acquisition unit 111 that acquires a load applied to the drive source driving the agitator member 68 and a determination unit 112 that determines the position of the agitator member 68 in the collection container 61 according to the acquired load.

The load acquisition unit 111 acquires the magnitude of the current from the ammeter 82 that measures the current flowing through the drive motor 81, and calculates the magnitude of the torque as the load applied to the drive motor 81 based on the magnitude of the current. In the present exemplary embodiment, the drive motor 81 drives the conveying auger 72 and the like in addition to the agitator member 68, and the load applied to the drive motor 81 is not limited to the load for driving the agitator member 68. The load for driving the agitator member 68 may be obtained by subtracting the load for driving the components other than the agitator member 68 from the load applied to the drive motor 81.

Here, the magnitude of the current flowing through the drive motor 81 in a state where the waste powder collection bottle 60 is empty may be defined as a reference value, and the amount of increase from the reference value may be defined as the load applied to the drive motor 81 by the agitator member 68. As a method of acquiring the reference value, for example, an average of current values acquired at the initial stage after the replacement of the waste powder collection bottle 60 can be used as the reference value. Note that this initial stage is a stage before the waste powder in the waste powder collection bottle 60 is deposited up to the height of the agitator member 68. This reference value is stored in the storage unit 130.

The determination unit 112 determines whether the load applied to the drive motor 81 has reached a predetermined value. Specifically, it is determined whether the value of the torque calculated by the load acquisition unit 111 is larger than a predetermined value. In other words, the determination unit 112 determines the position of the agitator member 68 based on the load applied when the distal end portion 68a of the agitator member 68 comes into contact with the brake part 69 provided on the upper side of the collection container 61.

Here, the predetermined value is set in advance as a value for determining that the distal end portion 68a has come into contact with the brake part 69, and is stored in storage unit 130. The predetermined value is set to, for example, a value which is larger than the magnitude of a variation in the torque generated in the normal image forming operation and smaller than the amount of increase in the load generated when the distal end portion 68a comes into contact with the brake part 69. Furthermore, the determination unit 112 may determine that the distal end portion 68a and the brake part 69 are in contact with each other when the value of the calculated torque exceeds the predetermined value for several seconds, for example, instead of making such determination in response to the value of the calculated torque exceeding the predetermined value only once.

When the distal end portion 68a of the agitator member 68 comes into contact with the brake part 69, the output unit 120 outputs, to the user interface 90, the collection amount information that is information about the amount of waste powder stored in the collection container 61. In other words, the output unit 120 outputs the collection amount information according to the position of the distal end portion 68a of the agitator member 68. Furthermore, examples of the collection amount information include a notification indicating that the collection container 61 is full, a notification indicating that the collection container 61 is nearly full, a notification prompting replacement of the waste powder collection bottle 60, and the like for example.

### Full State Detection Processing

Next, processing executed by the controller 100 for detecting that the collection container 61 is full will be described.

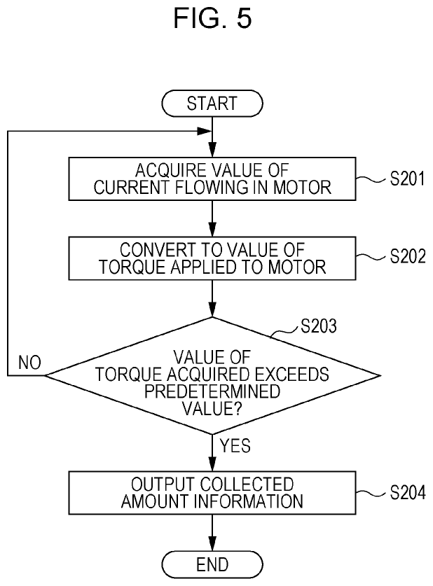

FIG. 5 is a flowchart of processing for detecting that the collection container 61 is full.

The controller 100 acquires the value of the current flowing through the drive motor 81 from the ammeter 82 constantly or at a predetermined timing (step 201). The controller 100 converts the acquired current value into a value of torque applied to the drive motor 81 (step 202). The controller 100 determines whether the acquired value of torque exceeds the predetermined value (step 203). When the acquired torque value is smaller than the predetermined value (NO in step 203), the processing returns to step 201. When the value of the acquired torque exceeds the predetermined value in step 203 (YES in step 203), the controller 100 outputs the collection amount information to the user interface 90 (step 204), and the processing ends.

### Other Configurations

In the present exemplary embodiment, as the method of detecting the load applied to the drive source, the load applied to the drive motor 81 is detected based on the magnitude of the current flowing through the drive motor 81, but the method of detecting the load applied to the drive source is not limited thereto. As the method of detecting the load applied to the drive source, a load applied to any of the members that transmit the power from the drive motor 81 to the agitator member 68 may be detected. For example, a torque sensor may be provided on any one of the gears of the gear group 78 that rotates the coupling receiving member 74, and a load applied to the gear group 78 may be detected by the torque sensor, as the load applied to the drive source.

In the image forming apparatus 1 to which the present exemplary embodiment is applied, the full state of the waste powder collection bottle 60 is detected based on the load applied to the drive motor 81 that drives the agitator member 68. Furthermore, in the image forming apparatus 1 to which the present exemplary embodiment is applied, as illustrated in FIGS. 3A to 3D, the agitator member 68 conveys the waste powder while being disposed over the waste powder until the inside of the collection container 61 changes from the empty state to the full state. Therefore, the frictional force that the agitator member 68 receives from the waste powder is smaller than that in a case where the agitator member 68 is buried in the waste powder, and a variation in the load applied to the drive motor 81 that drives the agitator member 68 remains small until a point immediately before the collection container 61 reaches the full state from the empty state. When the distal end portion 68a of the agitator member 68 comes into contact with the brake part 69, the frictional force received by the agitator member 68 increases. Therefore, the image forming apparatus 1 to which the present exemplary embodiment is applied achieves high accuracy in detection of the full state compared with a case where the load applied to the agitator member 68 gradually increases.

Note that although the position of the agitator member 68 is detected based on the load applied to the drive source in the present exemplary embodiment, the method of detecting the position of the agitator member 68 is not limited thereto. For example, a pressure sensor may be provided at a position on the upper side of the collection container 61 to which the distal end portion 68a of the agitator member 68 comes into contact. In this case, the position of the agitator member 68 is detected depending on whether the pressure sensor reacts.

In the present exemplary embodiment as described above, the full state is detected according to the position of the agitator member 68 that moves in the collection container 61. Thus, as compared with the case where the full state is detected by using the transmission-type sensor, the full state can be accurately detected without being affected by the waste powder scattering in the waste powder collection bottle.

### APPENDIX

(((1)))

An image forming apparatus comprising:
a collection container configured to receive waste powder discharged from an image forming unit and store the waste powder;
a conveying portion that is swingably supported in a cantilevered manner in the collection container and is inclined according to a height of the waste powder deposited in the collection container to convey the waste powder; and
an output unit configured to output collection amount information that is information on an amount of the waste powder stored in the collection container based on a position of the conveying portion in the collection container.

(((2)))

The image forming apparatus according to (((1))), wherein the output unit outputs the collection amount information according to a position of a distal end portion that is a distal end of the conveying portion on a free end side.

(((3)))

The image forming apparatus according to (((2))), wherein the output unit outputs the collection amount information when the distal end portion comes into contact with an upper side of the collection container.

(((4)))

The image forming apparatus according to (((3))), further including a measurement unit configured to measure a load applied to a drive source configured to drive the conveying portion, wherein
the output unit outputs the collection amount information when the load measured by the measurement unit reaches a predetermined value.

(((5)))

The image forming apparatus according to (((4))), wherein
the measurement unit measures the load at a point when a distal end portion that is a distal end of the conveying portion on a free end side comes into contact with the upper side of the collection container, and
the output unit outputs the collection amount information based on the load at the point when the distal end portion comes into contact with the upper side of the collection container measured by the measurement unit.

(((6)))

The image forming apparatus according to any one of (((1))) to (((5))), wherein the collection container includes a resistance applying portion that is provided on an upper side of the collection container, and is configured to generate, when a distal end portion that is a distal end of the conveying portion on a free end side comes into contact with the resistance applying portion, a frictional resistance for the distal end portion.

(((7)))

The image forming apparatus according to any one of (((2))) to (((6))), wherein a surface of the distal end portion is processed to have high surface roughness.

(((8)))

The image forming apparatus according to (((1))), wherein the collection container is provided with a pressure sensor at a position, on an upper side of the collection container, with which a distal end portion that is a distal end of the conveying portion on a free end side comes into contact.

(((9)))

A waste powder collection bottle comprising:
a collection container configured to receive waste powder discharged from an image forming unit and store the waste powder;
a conveying portion that is swingably supported in a cantilevered manner in the collection container and is inclined according to a height of the waste powder deposited in the collection container to convey the waste powder; and
a resistance applying portion that is provided on an upper side in the collection container, and is configured to generate, when a distal end portion that is a distal end of the conveying portion on a free end side comes into contact with the resistance applying portion, a frictional resistance for the distal end portion.

What is claimed is:

1. An image forming apparatus comprising:
a collection container configured to receive waste powder discharged from an image forming unit and store the waste powder;
a conveying portion that is swingably supported in a cantilevered manner in the collection container and is inclined according to a height of the waste powder deposited in the collection container to convey the waste powder; and
an output unit configured to output collection amount information that is information on an amount of the waste powder stored in the collection container based on a position of the conveying portion in the collection container.

2. The image forming apparatus according to claim 1, wherein the output unit outputs the collection amount information according to a position of a distal end portion that is a distal end of the conveying portion on a free end side.

3. The image forming apparatus according to claim 2, wherein the output unit outputs the collection amount information when the distal end portion comes into contact with an upper side of the collection container.

4. The image forming apparatus according to claim 3, further comprising a measurement unit configured to measure a load applied to a drive source configured to drive the conveying portion, wherein
the output unit outputs the collection amount information when the load measured by the measurement unit reaches a predetermined value.

5. The image forming apparatus according to claim 4, wherein the measurement unit measures the load at a point when a distal end portion that is a distal end of the conveying portion on a free end side comes into contact with the upper side of the collection container, and
the output unit outputs the collection amount information based on the load at the point when the distal end portion comes into contact with the upper side of the collection container measured by the measurement unit.

6. The image forming apparatus according to claim 1, wherein the collection container includes a resistance applying portion that is provided on an upper side of the collection container, and is configured to generate, when a distal end portion that is a distal end of the conveying portion on a free end side comes into contact with the resistance applying portion, a frictional resistance for the distal end portion.

7. The image forming apparatus according to claim 6, wherein a surface of the distal end portion is processed to have high surface roughness.

8. The image forming apparatus according to claim 1, wherein the collection container is provided with a pressure sensor at a position, on an upper side of the collection container, with which a distal end portion that is a distal end of the conveying portion on a free end side comes into contact.

9. A waste powder collection bottle comprising:
a collection container configured to receive waste powder discharged from an image forming unit and store the waste powder;
a conveying portion that is swingably supported in a cantilevered manner in the collection container and is inclined according to a height of the waste powder deposited in the collection container to convey the waste powder; and
a resistance applying portion that is provided on an upper side in the collection container, and is configured to generate, when a distal end portion that is a distal end of the conveying portion on a free end side comes into contact with the resistance applying portion, a frictional resistance for the distal end portion.
